(19) United States
(12) Patent Application Publication
(10) Pub. No.: US 2026/0212230 A1
(43) Pub. Date: Jul. 23, 2026

(54) PROCESSOR-IMPLEMENTED SYSTEMS AND METHODS FOR CONTROLLING ACTIONS OF AI AGENTS

(71) Applicant: Salesforce, Inc., San Francisco, CA (US)

(72) Inventor: Kusuma Kumari Seshavarapu, Hyderabad (IN)

(73) Assignee: Salesforce, Inc., San Francisco, CA (US)

(21) Appl. No.: 19/035,819

(22) Filed: Jan. 23, 2025

(51) Int. Cl. G06N 5/045

(52) U.S. Cl. CPC G06N 5/045

(57) ABSTRACT

Processor-implemented methods and systems are disclosed for interacting with multiple artificial intelligence (AI) agents. Logging data is generated that captures actions the AI agents take. The logging data includes data inputs, decision processes, and final decisions of the AI agents. Primary data features that guided the final decisions of the AI agents are determined. Control of the AI agents is in response to human-understandable explanations of the AI agents'final decisions.

### TECHNICAL FIELD

Embodiments of the subject matter described herein relate generally to processor-implemented methods and systems involving artificial intelligence (AI) agents and more particularly to embodiments of the subject matter related to systems and methods for processor-implemented methods and systems for controlling AI agents.

### BACKGROUND

As organizations increasingly adopt AI agents to automate processes, enhance customer interactions, and drive decision-making, the lack of visibility and control over these agents create significant operational challenges. This might also cause customer attrition.

### BRIEF DESCRIPTION OF THE DRAWINGS

The present disclosure will hereinafter be described in conjunction with the following drawing figures, wherein like numerals denote like elements, and wherein:

FIG. 1 is a block diagram representation of a system for controlling actions of AI agents in accordance with at least one embodiment;

FIG. 2 is a block diagram representation of a system for controlling actions of AI agents in accordance with at least one embodiment;

FIG. 3 is a flow chart diagram representing an example operational scenario involving AI agents in accordance with at least one embodiment;

FIG. 4 is a user interface representation of an AI agent dashboard in accordance with at least one embodiment;

FIG. 5 is a block diagram representation of an example of an environment in which an on-demand database service can be used in accordance with some implementations and models;

FIG. 6 is a block diagram representation of example implementations of elements of FIG. 5 and example interconnections among these elements according to some implementations; and

FIG. 7 is a diagrammatic representation of a machine in an exemplary form of a computer system within which a set of instructions, for causing the machine to perform any one or more of the methodologies discussed herein, may be executed.

### DETAILED DESCRIPTION

Processor-implemented methods and systems are disclosed herein for interacting with multiple artificial intelligence (AI) agents. Logging data is generated that captures actions the AI agents take. The logging data includes data inputs, decision processes, and final decisions of the AI agents. Primary data features that guided the final decisions of the AI agents are determined. Control of the AI agents is in response to human-understandable explanations of the AI agents'final decisions.

As another example, processor-implemented methods and systems are disclosed for controlling multiple artificial intelligence (AI) agents. Logging data is generated, by one or more data processors, that captures actions the AI agents take. The logging data includes data inputs, decision processes, and final decisions of the AI agents. The final decisions of the AI agents are translated, by the one or more data processors, into human-understandable explanations of the AI agents'final decisions. Primary data features that guided the final decisions of the AI agents are determined by the one or more data processors. Alerts associated with the final decisions and the primary data features of the AI agents are determined, by the one or more data processors, based upon comparisons to pre-selected performance standards. A real-time view and control of the AI agents is provided, by the one or more data processors, to a display to a user. The control of the AI agents is in response to the human-understandable explanations of the AI agents'final decisions and the alerts.

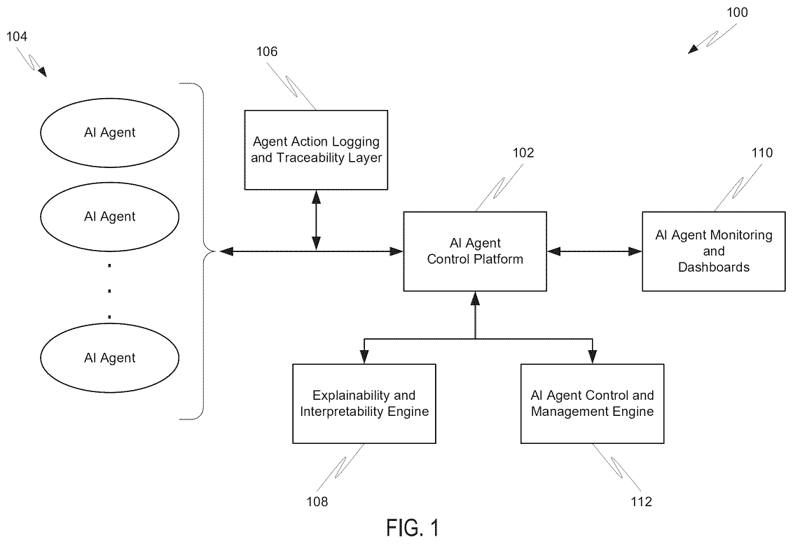

In one example embodiment, a processor-implemented system 100 for interacting and controlling multiple AI agents is disclosed in FIG. 1. With reference to FIG. 1, the system 100 includes a centralized platform 102 designed for providing real-time control and automated management of AI agents 104. The system 100 streamlines oversight across the deployed AI agents 104, enabling management and performance optimization based upon pre-selected performance criteria as well as fast responses to issues or anomalies.

More specifically, an action logging and traceability layer 106 is responsible for logging actions the AI agents 104 take, including the data inputs, decision process, and final output. An explainability and interpretability engine 108 translates agent decisions into human-understandable explanations. The explainability and interpretability engine 108 focuses on making black-box AI decisions clear for human understanding.

Real-time monitoring and dashboards 110 provide customers with a real-time view of AI agent actions and behaviors. Real-time monitoring generates automated alerts for predefined triggers, such as unexpected behavior, system failures, or deviations from expected actions. The automated alerts are provided to the dashboards for user notification.

Real-time monitoring can further include monitoring objective performance metrics so that organizations can gain significant insights into their AI agents'performance, identify areas for improvement, and ensure that they meet business objectives effectively. Regularly reviewing these metrics allows for continuous optimization of AI capabilities and enhances overall service delivery.

An AI agent control and management engine 112 provides capabilities to control one or more AI agents. For example, the AI agent control and management engine 112 allows operators to pause, restart, or modify AI agents 104 directly from a dashboard.

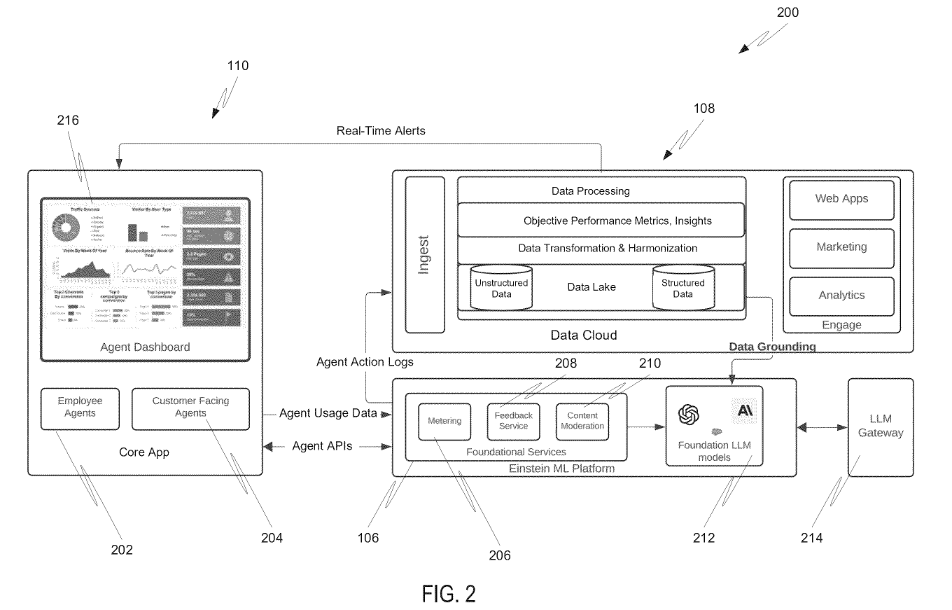

FIG. 2 is a process block diagram that depicts at 200 processor-implemented components for AI agent control and management. The agent action logging and traceability layer 106 logs actions of the AI employee agents 202 and customer-facing AI agents 204 take and stores them in action logs. For example, the action logs can contain: the input the agent received; the model(s) or algorithm(s) invoked; the features and data points used in decision-making; the output or decision; the action taken (e.g., customer response, recommendation, etc.); timestamp and agent ID; etc. A unique correlation ID can be used that ties together related actions or sessions for tracking complex workflows across multiple actions.

The agent action logging and traceability layer 106 can include a metering module 206, which tracks the usage and performance of the AI agents 202 and 204. A feedback service module 208 allows a human operator to reviews any feedback related to the AI agents 202 and 204 and, if valid, adjusts an AI agent's future decision-making by retraining the machine learning model used by the AI agent with the additional context. A content moderation module 210 performs the following operation: ensuring that the actions performed by the AI agents 202 and 204 on various content are monitored and logged.

The data in the action logs are provided to LLM models 212. Users can access the LLM models 212 through the LLM gateway 214 so that they can be utilized with the AI agents 202 and 204. The AI action logs generated by the agent action logging and traceability layer 106 are also provided to the explainability and interpretability engine 108.

The explainability and interpretability engine 108 translates agent decisions into human-understandable explanations. More specifically, the explainability and interpretability engine 108 includes a decision justification module which converts machine learning outputs (e.g., classification, regression results, etc.) into simple language. For example, if an agent denies a customer request, the system provides a human-readable reason (e.g., “Based on X customer data, the request was flagged due to high risk”).

The explainability and interpretability engine 108 further includes a feature attribution module which shows the key data points (features) that influenced the agent's decision. Tools, such as SHAP (SHapley Additive exPlanations) or LIME (Local Interpretable Model-agnostic Explanations), can be integrated to provide local model explanations. Additionally, the explainability and interpretability engine 108 can include an audit log API, which allows external systems or customer interfaces to request explanations of past actions.

The analysis provided by the explainability and interpretability engine 108 can be used for many purposes, such as by AI agent monitoring and dashboards component 110. This component 110 provides an agent dashboard 216 that displays a real-time view of AI agent actions and behaviors. This component 110 includes an action dashboard, where a user interface is provided for customers to view ongoing agent actions in real-time. The agent information can include the following: actions taken by agents; pending decisions; current workload or tasks in progress; anomalies flagged; decision heatmap (e.g., visualization of frequently used decision paths or common outcomes, providing insights into agent decision patterns); performance metrics, which tracks response times, error rates, successful interactions, and time-to-decision; etc.

The component 110 can also provide automated alerts for predefined triggers, such as unexpected behavior, system failures, or deviations from expected actions. Such processing can include abnormal behavior detection. This detection monitors for deviations from typical agent actions, potentially using anomaly detection algorithms. Alerts are raised if an agent acts outside of predefined behavior norms (e.g., providing a high volume of refunds or denying service frequently, etc.). Additionally, error logging can be done, which includes capturing instances where the agent could not complete an action or encountered a system failure. As another example, threshold-based alerts can be generated, which alert customers if agents exceed certain thresholds (e.g., customer complaints, response times, etc.).

Component 110 can further include monitoring and reporting the agent performance. By monitoring the following objective performance-based criteria, organizations can gain valuable insights into their AI agents'performance, identify areas for improvement, and ensure that they meet business objectives effectively. Regularly reviewing these metrics allows for continuous optimization of AI capabilities and enhances overall service delivery.

The metrics can include the following:
1. Accuracy: measures how often the AI agent provides correct answers or makes accurate predictions. High accuracy indicates that the AI agent is reliable and trustworthy in its responses, which is crucial for user satisfaction.
2. Response Time: the average time taken by the AI agent to respond to user queries. Faster response times enhance user experience and can significantly impact customer satisfaction, especially in time-sensitive situations.
3. Customer Satisfaction (CSAT) Score: a metric derived from user feedback after interactions with the AI agent, often measured through surveys. A high CSAT scores reflect positive user experiences and indicate that the AI is meeting customer needs effectively.
4. First Contact Resolution (FCR) Rate: the percentage of customer inquiries resolved during the first interaction with the AI agent. A high FCR rate indicates efficiency and effectiveness, reducing the need for follow-up interactions and enhancing customer satisfaction.
5. Automated Resolution Rate: the proportion of issues resolved by the AI agent without human intervention. Higher rates suggest that the AI is capable of handling a significant number of queries independently, reducing workload on human agents.
6. Average Handle Time (AHT): the average duration taken to resolve a customer inquiry, including both talk time and any necessary follow-up actions. Monitoring AHT helps in assessing efficiency; shorter handle times generally correlate with improved operational efficiency.
7. Sentiment Analysis: evaluates customer emotions during interactions with the AI agent, providing insights into user satisfaction and experience. Understanding sentiment can help identify areas for improvement in communication style and responsiveness.
8. Engagement Metrics: metrics such as conversation length, frequency of interactions, and user retention rates. These metrics provide insights into how users interact with the AI agent and can indicate its effectiveness in maintaining user interest.
9. Transfer Rate to Human Agents: The percentage of interactions that require escalation to human agents. Lower transfer rates suggest that the AI is effectively handling queries; higher rates may indicate limitations in its capabilities or knowledge base.
10. Cost per Resolution (CPR): the average cost incurred to resolve a customer issue through the AI agent. Understanding CPR helps evaluate the financial efficiency of deploying AI solutions compared to traditional methods.

It should be understood that additional technical features can be included with one or more the disclosed systems and methods. For example, a learning and adaptation feedback loop can be included that allows customers to provide feedback on agent behavior, which can help improve future decisions. This can further include a customer feedback module, where customers can manually flag agent actions as correct or incorrect and provide feedback on decision-making. Additionally, a correction interface can be provided, where if a customer flags an action as incorrect, the system asks for further context to feed into the agent's learning pipeline. Still further, an active learning module can be included that incorporates customer feedback into the agent's future decision-making, thereby allowing the system to adapt to evolving customer preferences or policies.

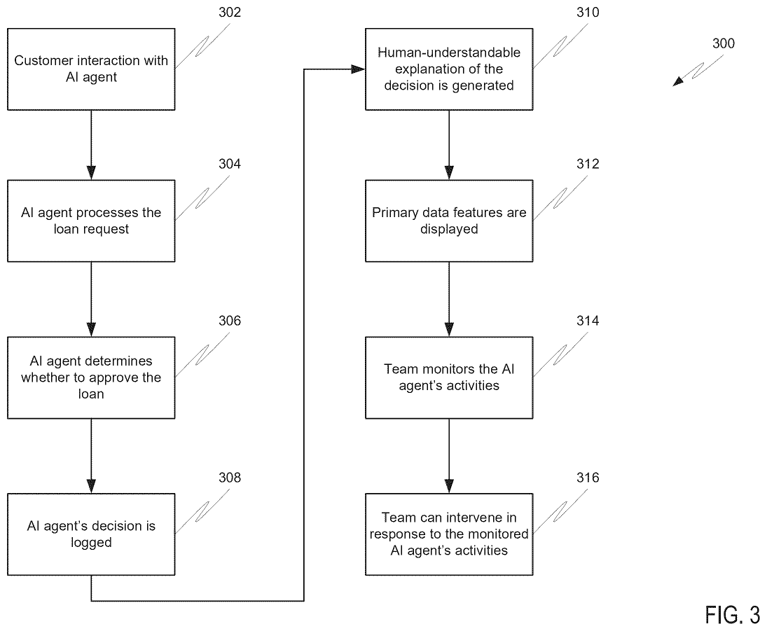

FIG. 3 is a flow chart diagram depicting an operational scenario example at 300 for monitoring and controlling an AI agent's decision regarding a loan approval. In the operational scenario example, a customer interacts with an AI agent regarding a loan approval at step 302. This can include a customer providing customer data related to the loan approval process.

The AI agent's decision process occurs at steps 304, 306, and 308. At step 304, the AI agent processes the request based on customer data (e.g., credit score, income, previous interactions, etc.). At step 306, the AI agent uses machine learning models to decide whether to approve or deny the loan. At step 308, the decision is logged with all relevant data and model outputs.

The explainability and interpretability engine processing occurs at steps 310 and 312. At step 310, The engine provides a human-readable explanation for the denial: “Loan was denied due to credit score being below 600 and a high-risk score based on recent missed payments.” At step 312, the primary data features (e.g., key contributing factors, etc.) are displayed in the dashboard (e.g., credit score 580, risk score 7/10, etc.).

The AI agent monitoring and dashboards processing occurs at steps 314 and 316. At step 314, a customer service team monitors the AI agent's decision in real-time using the dashboard. If the decision appears incorrect to them, they can immediately intervene and adjust the outcome at step 316. Additionally, alert processing can be performed in the operational scenario, such as in the following manner. The platform detects that this is the third denial of a loan request within an hour for this particular demographic. An alert is raised and provided to the customer service team, signaling possible AI agent bias or a model drift issue.

The platform can also perform scaling, performance, and feedback operations. For example, the platform can auto scale the agents based on the load on the system in peak hours or during specific events, such as Black Friday store sales. With respect to performance, the platform determines that the self service AI agent has an average CSAT score of 4 and above, suggesting that the end users are satisfied with the agent interactions. With respect to feedback, the customer disputes the denial, and their feedback is recorded. A human operator reviews the feedback and, if valid, adjusts the agent's future decision-making by retraining the model with the additional context.

As can be appreciated in light of the disclosure, the order of operations within FIG. 3 and the other process block diagrams described herein is not limited to the sequential execution as illustrated in the figures but may be performed in one or more varying orders as applicable and in accordance with the present disclosure.

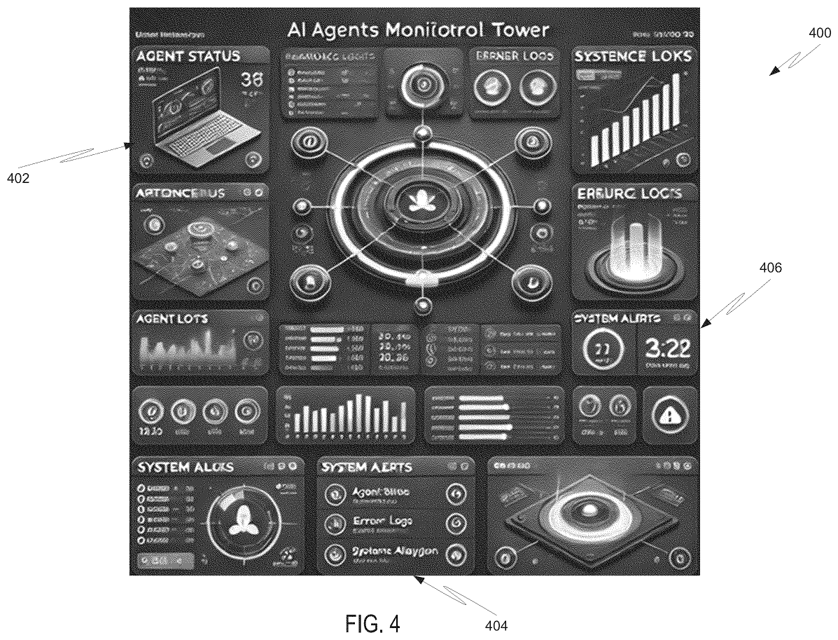

FIG. 4 depicts at 400 an example of an AI agent user interface diagram. The AI agent interface 400 provides customers with a real-time view of AI agent actions and behaviors. For example, the real-time view can include AI agent status information 40, such as actions taken by AI agents, pending decisions, current workload or tasks in progress, anomalies flagged, etc. The real-time view can further include alert displays 404 and 406 where abnormal behavior detection is displayed as well as error logging.

Depending upon the application at hand, the user interface can display many other types of information such as the following: traffic sources, visitors by user type, visits by week of the year, bounce rate by week of year, top-three channels by conversion, top-three campaigns by conversion, top-three pages by conversion, etc.

While examples have been used to disclose the systems and methods provided herein to enable any person of ordinary skill in the art to make and use the disclosed systems and methods, the examples disclosed herein are to be considered non-limiting. As an illustration, Many different implementations can be used for logging, such as software instrumentation for logging data that can collect the performance objective data for AI agents as well as Apache Kafka for high-volume data ingestion into a data cloud. Additionally, many different implementations can be used to help with explainability and interpretability, such as SHAP, LIME for model interpretability, integrated with the AI models. For AI agent monitoring and dashboard displays, Grafana can be used for real time monitoring and Tableau for analytics and reporting. For alerts, rule-based alerting systems can be used. For feedback loops, custom-built feedback forms can be used with integrations into training pipelines using platforms like Einstein/SageMaker for retraining models.

As another example, one or more platforms described herein can include customer facing and domain centric monitoring. The platform explains in the context of the use case of FIG. 3, that a loan agent has processed so many loans in 1 hour/1 day, number of approved loans vs rejected etc. The performance objective metrics of each type of AI agent could be different and those performance objective metrics could be tracked and made available through the platform. The agent performance objective metrics also would provide the customers with confidence in their AI strategy and can be used to optimize their workforce/business operations. The real time monitoring metrics would proactively alert the customers on any anomaly/abnormal behavior of the agents.

Still further, one or more embodiments of the systems and methods described herein can be configured to translate agent decisions into human-understandable explanations, make black-box AI decisions clearer to the user, provide a user interface where customers can view ongoing agent actions in real-time, and provide automated alerts for predefined triggers, such as unexpected behavior, system failures, or deviations from expected actions. Additionally, such systems and methods can be configured to provide domain centric monitoring, visibility into LLMs, customer-facing user interface, centralized platform for monitoring agents, and identification of primary data features involved in AI agent decisions.

Still further, one or more embodiments of the systems and methods described herein can be configured to address one or more of the following technical problems:
Lack of Transparency: Operators lack a clear, unified view of what AI agents are doing across various systems, making it difficult to verify if actions align with expected behaviors.
Delayed Issue Detection: Errors or anomalies in agent performance may go undetected until they escalate, causing potential harm to customer experience, brand reputation, or compliance.
Inability to Scale Monitoring Efforts: As the number of AI agents grows, manual monitoring becomes inefficient, error-prone, and resource-intensive.
Limited Proactive Management: Without real-time insights, operators cannot take preventative actions to manage system health, optimize agent performance, or minimize risk.
Inability to measure the value of the Agents: objective performance-based metrics allow businesses to measure the value of agents and deploy them strategically, such as to ensure compliance with organizational standards and regulatory requirements.

The AI interaction and control systems and methods as described herein can be used within many different software environments. For example, one or more of the systems and methods described herein can be deployed as a cloud-based platform and made available as a Software as a Service (SaaS) solution.

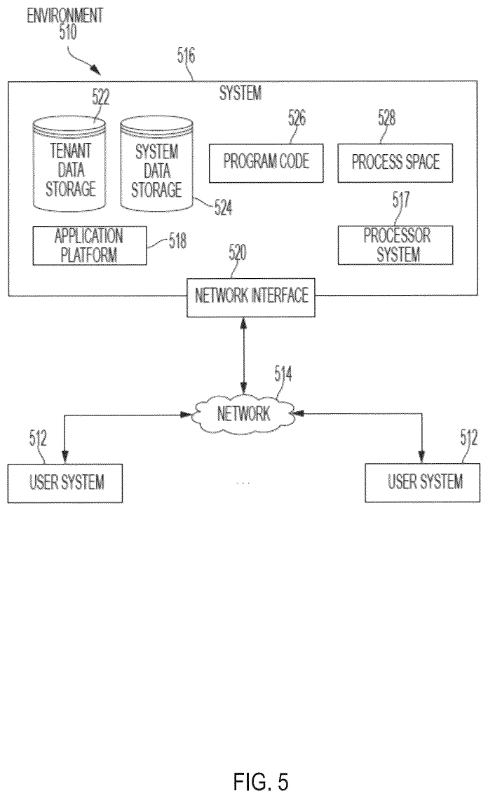

As another an example, FIG. 5 shows a block diagram of an example of an environment 510 in which an on-demand database service can be used with the AI interaction and control systems and methods disclosed herein.

The environment 510 includes user systems 512 (also referred to a client device), a network 514, a database system 516 (also referred to herein as a “cloud-based system”), a processor system 517, an application platform 518, a network interface 520, tenant database 522 for storing tenant data 523, system database 524 for storing system data 525, program code 526 for implementing various functions of the system 516, and process space 528 for executing database system processes and tenant-specific processes, such as running applications as part of an application hosting service. In some other implementations, environment 510 may not have all of these components or systems, or may have other components or systems instead of, or in addition to, those listed above.

In some implementations, the environment 510 is an environment in which an on-demand database service exists. An on-demand database service, such as that which can be implemented using the system 516, is a service that is made available to users outside of the enterprise(s) that own, maintain or provide access to the system 516. As described above, such users generally do not need to be concerned with building or maintaining the system 516. Instead, resources provided by the system 516 may be available for such users'use when the users need services provided by the system 516; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 518 can be a framework that allows the applications of system 516 to execute, such as the hardware or software infrastructure of the system 516. In some implementations, the application platform 518 enables the creation, management and execution of one or more applications developed by the provider of the on-demand database service, users accessing the on-demand database service via user systems 512, or third-party application users accessing the on-demand database service via user systems 512.

In some implementations, the system 516 implements a web-based customer relationship management (CRM) system. For example, in some such implementations, the system 516 includes application servers configured to implement and execute CRM software applications as well as provide related data, code, forms, renderable webpages and documents and other information to and from user systems 512 and to store to, and retrieve from, a database system related data, objects, and Webpage content. In some MTS implementations, data for multiple tenants may be stored in the same physical database object in tenant database 522. In some such implementations, tenant data is arranged in the storage medium(s) of tenant database 522 so that data of one tenant is kept logically separate from that of other tenants so that one tenant does not have access to another tenant's data, unless such data is expressly shared. The system 516 also implements applications other than, or in addition to, a CRM application. For example, the system 516 can provide tenant access to multiple hosted (standard and custom) applications, including a CRM application. User (or third-party user) applications, which may or may not include CRM, may be supported by the application platform 518. The application platform 518 manages the creation and storage of the applications into one or more database objects and the execution of the applications in one or more virtual machines in the process space of the system 516.

According to some implementations, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 514 can be or include any network or combination of networks of systems or devices that communicate with one another. For example, the network 514 can be or include any one or any combination of a LAN (local area network), WAN (wide area network), telephone network, wireless network, cellular network, point-to-point network, star network, token ring network, hub network, or other appropriate configuration. The network 514 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 512 can communicate with system 516 using TCP/IP and, at a higher network level, other common Internet protocols to communicate, such as HTTP, FTP, AFS, WAP, etc. In an example where HTTP is used, each user system 512 can include an HTTP client commonly referred to as a “web browser” or simply a “browser” for sending and receiving HTTP signals to and from an HTTP server of the system 516. Such an HTTP server can be implemented as the sole network interface 520 between the system 516 and the network 514, but other techniques can be used in addition to or instead of these techniques. In some implementations, the network interface 520 between the system 516 and the network 514 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 512 can be implemented as any computing device(s) or other data processing apparatus or systems usable by users to access the database system 516. For example, any of user systems 512 can be a desktop computer, a workstation, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 512 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 516) of the user system 512 to access, process and view information, pages and applications available to it from the system 516 over the network 514.

Each user system 512 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 512 in conjunction with pages, forms, applications and other information provided by the system 516 or other systems or servers. For example, the user interface device can be used to access data and applications hosted by system 516, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 512 may differ in their respective capacities, and the capacity of a particular user system 512 can be entirely determined by permissions (permission levels) for the current user of such user system. For example, where a salesperson is using a particular user system 512 to interact with the system 516, that user system can have the capacities allotted to the salesperson. However, while an administrator is using that user system 512 to interact with the system 516, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users'respective security or permission levels (also referred to as “authorizations”).

According to some implementations, each user system 512 and some or all of its components are operator-configurable using applications, such as a browser, including computer code executed using a central processing unit (CPU) such as an Intel Pentium® processor or the like. Similarly, the system 516 (and additional instances of an MTS, where more than one is present) and all of its components can be operator-configurable using application(s) including computer code to run using the processor system 517, which may be implemented to include a CPU, which may include an Intel Pentium® processor or the like, or multiple CPUs.

The system 516 includes tangible computer-readable media having non-transitory instructions stored thereon/in that are executable by or used to program a server or other computing system (or collection of such servers or computing systems) to perform some of the implementation of processes described herein. For example, computer program code 526 can implement instructions for operating and configuring the system 516 to intercommunicate and to process webpages, applications and other data and media content as described herein. In some implementations, the computer code 526 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, JAVA®, JAVASCRIPT®, ActiveX®, any other scripting language, such as VBScript®, and many other programming languages as are well known may be used. (JAVA™ is a trademark of Sun Microsystems, Inc.).

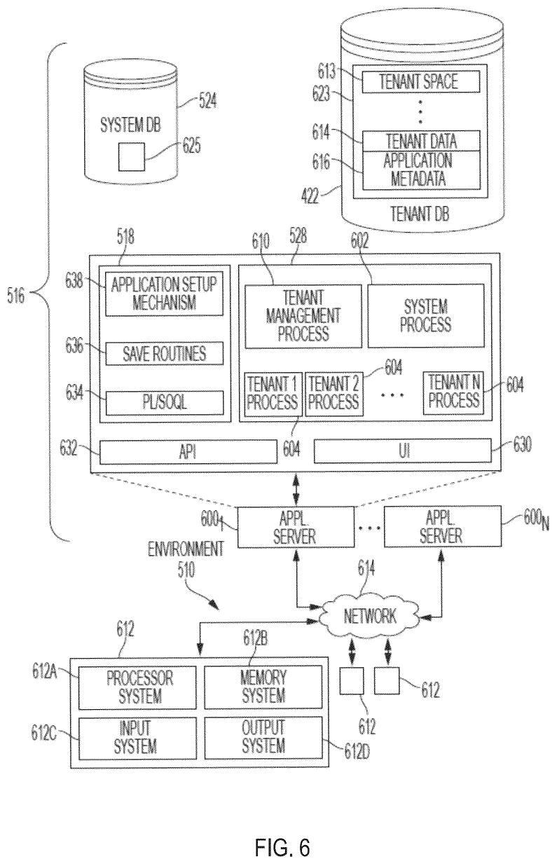

FIG. 6 shows a block diagram of example implementations of elements in FIG. 5 and example interconnections between these elements according to some implementations. That is, FIG. 6 also illustrates environment 510, but FIG. 6, various elements of the system 516 and various interconnections between such elements are shown with more specificity according to some more specific implementations. Elements from FIG. 6 that are also shown in FIG. 5 will use the same reference numbers in FIG. 6 as were used in FIG. 5. Additionally, in FIG. 6, the user system 612 includes a processor system 612A, a memory system 612B, an input system 612C, and an output system 612D. The processor system 612A can include any suitable combination of one or more processors. The memory system 612B can include any suitable combination of one or more memory devices. The input system 612C can include any suitable combination of input devices, such as one or more touchscreen interfaces, keyboards, mice, trackballs, scanners, cameras, or interfaces to networks. The output system 612D can include any suitable combination of output devices, such as one or more display devices, printers, or interfaces to networks.

In FIG. 6, the network interface 520 of FIG. 5 is implemented as a set of HTTP application servers 6001-600N. Each application server 600, also referred to herein as an “app server,” is configured to communicate with tenant database 522 and the tenant data 623 therein, as well as system database 524 and the system data 625 therein, to serve requests received from the user systems 612. The tenant data 623 can be divided into individual tenant storage spaces 613, which can be physically or logically arranged or divided. Within each tenant storage space 613, tenant data 614 and application metadata 616 can similarly be allocated for each user. For example, a copy of a user's most recently used (MRU) items can be stored to tenant data 614. Similarly, a copy of MRU items for an entire organization that is a tenant can be stored to tenant storage space 613.

The process space 528 includes system process space 602, individual tenant process spaces 604 and a tenant management process space 610. The application platform 518 includes an application setup mechanism 638 that supports application users'creation and management of applications. Such applications and others can be saved as metadata into tenant database 522 by save routines 636 for execution by subscribers as one or more tenant process spaces 604 managed by tenant management process 610, for example. Invocations to such applications can be coded using PL/SOQL 634, which provides a programming language style interface extension to API 632. Invocations to applications can be detected by one or more system processes, which manage retrieving application metadata 616 for the subscriber making the invocation and executing the metadata as an application in a virtual machine.

The system 516 of FIG. 6 also includes a user interface (UI) 630 and an application programming interface (API) 632 to system 516 resident processes to users or users at user systems 612. In some other implementations, the environment 510 may not have the same elements as those listed above or may have other elements instead of, or in addition to, those listed above.

Each application server 600 can be communicably coupled with tenant database 522 and system database 524, for example, having access to tenant data 623 and system data 625, respectively, via a different network connection. For example, one application server 6001 can be coupled via the network 514 (for example, the Internet), another application server 600N can be coupled via a direct network link, and another application server (not illustrated) can be coupled by yet a different network connection. Transfer Control Protocol and Internet Protocol (TCP/IP) are examples of typical protocols that can be used for communicating between application servers 600 and the system 516. However, it will be apparent to one skilled in the art that other transport protocols can be used to optimize the system 516 depending on the network interconnections used.

In some implementations, each application server 600 is configured to handle requests for any user associated with any organization that is a tenant of the system 516. Because it can be desirable to be able to add and remove application servers 600 from the server pool at any time and for various reasons, in some implementations there is no server affinity for a user or organization to a specific application server 600. In some such implementations, an interface system implementing a load balancing function (for example, an F5 Big-IP load balancer) is communicably coupled between the application servers 600 and the user systems 612 to distribute requests to the application servers 600. In one implementation, the load balancer uses a least-connections algorithm to route user requests to the application servers 600. Other examples of load balancing algorithms, such as round robin and observed-response-time, also can be used. For example, in some instances, three consecutive requests from the same user could hit three different application servers 600, and three requests from different users could hit the same application server 600. In this manner, by way of example, system 516 can be a multi-tenant system in which system 516 handles storage of, and access to, different objects, data and applications across disparate users and organizations.

In one example storage use case, one tenant can be a company that employs a sales force where each salesperson uses system 516 to manage aspects of their sales. A user can maintain contact data, leads data, customer follow-up data, performance data, goals and progress data, etc., all applicable to that user's personal sales process (for example, in tenant database 522). In an example of an MTS arrangement, because all of the data and the applications to access, view, modify, report, transmit, calculate, etc., can be maintained and accessed by a user system 612 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users'data regardless of the employers of each user, some data can be organization-wide data shared or accessible by several users or all of the users for a given organization that is a tenant. Thus, there can be some data structures managed by system 516 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 516 also can maintain system level data usable by multiple tenants or other data. Such system level data can include industry reports, news, postings, and the like that are sharable among tenants.

In some implementations, the user systems 612 (which also can be client systems) communicate with the application servers 600 to request and update system-level and tenant-level data from the system 516. Such requests and updates can involve sending one or more queries to tenant database 522 or system database 524. The system 516 (for example, an application server 600 in the system 516) can automatically generate one or more SQL statements (for example, one or more SQL queries) designed to access the desired information. System database 524 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects or may be allowed to customize standard entities or objects, for example by creating custom fields for standard objects, including custom index fields. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

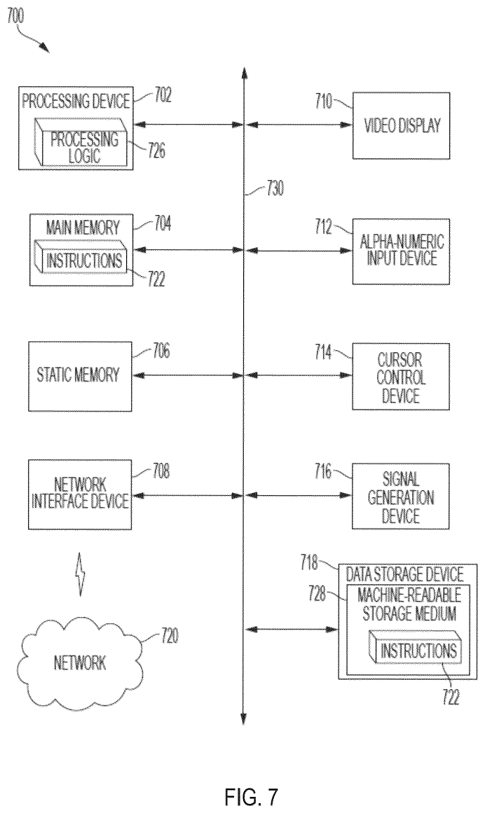

FIG. 7 illustrates a diagrammatic representation of a machine in the exemplary form of a computer system 700 within which a set of instructions for causing the machine to perform any one or more of the methodologies discussed herein, may be executed. The system 700 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a user system, a client device, or a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In at least one embodiment, computer system 700 may represent, for example, elements of the cloud-based computing platform or any other elements of FIG. 1 (e.g. clients, computing systems used by the customers 150, the third-party application exchange 160) or any elements of FIGS. 7 through 5, etc.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a computer-readable medium 728 on which is stored one or more sets of instructions 722 (e.g., instructions of in-memory buffer service 94) embodying any one or more of the methodologies or functions described herein. The instructions 722 may also reside, completely or at least partially, within the main memory 704 and/or within processing logic 726 of the processing device 702 during execution thereof by the computer system 700, the main memory 704 and the processing device 702 also constituting computer-readable media. The instructions may further be transmitted or received over a network 720 via the network interface device 708.

While the computer-readable storage medium 728 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor,” “processor system,” or “processing system” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general-purpose digital computer, by using a special-purpose computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, at least one embodiment of a system or a component may employ various integrated circuit components, e.g., memory elements, digital signal processing elements, logic elements, look-up tables, or the like, which may carry out a variety of functions under the control of one or more microprocessors or other control devices.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing,” “determining,” “analyzing,” “identifying,” “adding,” “displaying,” “generating,” “querying,” “creating,” “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

Any suitable programming language can be used to implement the routines of particular embodiments including C, C++, JAVA®, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one example embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those of ordinary skill in the art with a convenient road map for implementing the described embodiments. It should be understood that various changes can be made in the function and arrangement of elements without departing from the scope defined by the claims, which includes known equivalents and foreseeable equivalents at the time of filing this patent application.

What is claimed is:

1. A processor-implemented method for controlling multiple artificial intelligence (AI) agents, said method comprising:
generating logging data, by one or more data processors, that captures actions the AI agents take, wherein the logging data includes data inputs, decision processes, and final decisions of the AI agents;
translating, by the one or more data processors, the final decisions of the AI agents into human-understandable explanations of the AI agents'final decisions;
determining, by the one or more data processors, primary data features that guided the final decisions of the AI agents;
determining, by the one or more data processors, alerts associated with the final decisions and the primary data features of the AI agents based upon comparisons to pre-selected performance standards; and
providing, by the one or more data processors, to a display to a user a real-time view and control of the AI agents, wherein the control of the AI agents is in response to the human-understandable explanations of the AI agents'final decisions and the alerts.

2. The method of claim 1, wherein the actions the AI agents take include using machine learning models to decide whether to proceed with a customer transaction.

3. The method of claim 1, wherein the translating of the final decisions of the AI agents includes converting machine learning outputs into simple human-understandable language.

4. The method of claim 3, wherein the machine learning outputs include classification results or regression results.

5. The method of claim 4, wherein the translated final decisions of the AI agents are monitored by customers for compliance with pre-specified performance objective metrics.

6. The method of claim 5, wherein the monitored translated final decisions of the AI agents includes overriding of an action by one of the AI agents after an alert has been provided to one or more of the customers.

7. The method of claim 5, wherein the pre-specified performance objective metrics are domain-centric.

8. The method of claim 5, wherein the pre-specified performance objective metrics include two or more of the following: accuracy metrics, response time metrics, customer satisfaction metrics, first contact resolution metrics, automated resolution rate metrics, average handle time metrics, sentiment analysis metrics, engagement metrics, transfer rate to human agent metrics, and cost per resolution metrics.

9. The method of claim 1, wherein the primary data features indicate the key data points that influenced the AI agents'decision.

10. The method of claim 1, wherein one or more machine learning models are retrained based upon reviews of the translated final decisions of the AI agents.

11. A system for controlling multiple artificial intelligence (AI) agents, the system comprising:
at least one or more processors; and
at least one non-transitory machine-readable storage medium that stores instructions configurable to be executed by the at least one processor to:
generate logging data, by one or more data processors, that captures actions the AI agents take, wherein the logging data includes data inputs, decision processes, and final decisions of the AI agents;
translate, by the one or more data processors, the final decisions of the AI agents into human-understandable explanations of the AI agents'final decisions;
determine, by the one or more data processors, primary data features that guided the final decisions of the AI agents;
determine, by the one or more data processors, alerts associated with the final decisions and the primary data features of the AI agents based upon comparisons to pre-selected performance standards; and
provide, by the one or more data processors, to a display to a user a real-time view and control of the AI agents, wherein the control of the AI agents is in response to the human-understandable explanations of the AI agents'final decisions and the alerts.

12. The system of claim 11, wherein the actions the AI agents take include using machine learning models to decide whether to proceed with a customer transaction.

13. The system of claim 11, wherein the translating of the final decisions of the AI agents includes converting machine learning outputs into simple human-understandable language.

14. The system of claim 13, wherein the machine learning outputs include classification results or regression results.

15. The system of claim 14, wherein the translated final decisions of the AI agents are monitored by customers for compliance with pre-specified performance objective metrics.

16. The system of claim 15, wherein the monitored translated final decisions of the AI agents includes overriding of an action by one of the AI agents after an alert has been provided to one or more of the customers.

17. The system of claim 15, wherein the pre-specified performance objective metrics are domain-centric.

18. The system of claim 15, wherein the pre-specified performance objective metrics include two or more of the following: accuracy metrics, response time metrics, customer satisfaction metrics, first contact resolution metrics, automated resolution rate metrics, average handle time metrics, sentiment analysis metrics, engagement metrics, transfer rate to human agent metrics, and cost per resolution metrics.

19. The system of claim 11, wherein the primary data features indicate the key data points that influenced the AI agents'decision; wherein one or more machine learning models are retrained based upon reviews of the translated final decisions of the AI agents.

20. A non-transitory machine-readable storage medium that stores instructions executable by at least one or more data processors for controlling multiple artificial intelligence (AI) agents, the instructions configurable to cause the at least one processor to perform operations comprising:
generating logging data, by the one or more data processors, that captures actions the AI agents take, wherein the logging data includes data inputs, decision processes, and final decisions of the AI agents;
translating, by the one or more data processors, the final decisions of the AI agents into human-understandable explanations of the AI agents'final decisions;
determining, by the one or more data processors, primary data features that guided the final decisions of the AI agents;
determining, by the one or more data processors, alerts associated with the final decisions and the primary data features of the AI agents based upon comparisons to pre-selected performance standards; and
providing, by the one or more data processors, to a display to a user a real-time view and control of the AI agents, wherein the control of the AI agents is in response to the human-understandable explanations of the AI agents'final decisions and the alerts.
